(19) United States
(12) Patent Application Publication
(10) Pub. No.: US 2015/0127679 A1
(43) Pub. Date: May 7, 2015

(54) SYSTEM AND METHOD FOR IDENTIFYING AND SYNCHRONIZING DATA FROM MULTIPLE BACKEND ENTERPRISE COMPUTER SYSTEMS TO MULTIPLE TYPES OF MOBILE DEVICES

(71) Applicant: aMind Solutions, LLC, San Ramon, CA (US)

(72) Inventors: Robert Llewellyn Wing, Longmont, CO (US); George G. Kibilov, Santa Clara, CA (US)

(21) Appl. No.: 14/531,093

(22) Filed: Nov. 3, 2014

Related U.S. Application Data
(60) Provisional application No. 61/899,760, filed on Nov. 4, 2013.

(51) Int. Cl. G06F 17/30; G06F 11/07

(52) U.S. Cl. CPC G06F 17/30864; G06F 17/30477; G06F 11/0793
USPC 707/770

(57) ABSTRACT

A mobile framework server (MFS) may periodically obtain from an enterprise system information for a user who subscribed or is assigned to receive enterprise data. The MFS may determine whether the information indicates a change and whether the change is associated with a new record. If so, a new subscription is needed. To prepare data for the new subscription, the MFS may consult a canonical data model to determine what fields are needed for the new record and where the data for the fields are stored at the backend, perhaps managed by disparate enterprise systems. The MFS may determine appropriate queries for those enterprise systems involved and obtain record details for the fields. The record details are transformed into subscription data and stored in a subscription format. Subsequently, the subscription data is sent to a mobile device associated with the user at a significantly improved synchronization rate.

### CROSS-REFERENCE TO RELATED APPLICATION(S)

This is a conversion of, and claims a benefit of priority under 35 U.S.C. §119 from U.S. Provisional Application No. 61/899,760, filed Nov. 4, 2013, which is hereby incorporated by reference as if set forth herein in its entirety, including all appendices attached thereto.

### COPYRIGHT NOTICE

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### TECHNICAL FIELD

This disclosure relates generally to enterprise mobility computing. More particularly, embodiments disclosed herein relate to synchronization of data between disparate backend enterprise systems and disparate mobile devices in a manner that allows reasonably complex enterprise application processes to be performed by enterprise mobile applications on the mobile devices without requiring persistent network connections to the backend enterprise systems, thereby enabling faster application performance on the mobile devices.

### BACKGROUND OF THE RELATED ART

Mobile devices such as smart phones, laptops, tablets, and so on have become a fixture in the lives of today's enterprise users. While their processing power and data storage capability continue to increase, mobile devices have yet to become a well-integrated part of today's enterprise systems. One reason is that enterprise application processes performed by enterprise systems can be quite complex and, as such, integrating mobile devices into an enterprise computing environment requires complex solutions that address issues such as security, control, reliability, performance, etc.

Within this disclosure, “enterprise systems” refers to the overall combination of large-scale computer hardware and software that an enterprise uses to organize and run its operations. Enterprise systems may have cross-organization capabilities and may directly support the execution of complex enterprise processes, information flows, reporting, and data analytics, serving as the foundation for the information technology (IT) infrastructure in complex organizations. For at least this reason, applications that are not part of the foundation for the IT infrastructure, even if they are deployed enterprise-wide, are excluded from the term “enterprise systems.” Examples of enterprise systems may include, but are not limited to, enterprise planning systems, enterprise resource planning (ERP) systems, customer relationship management (CRM) systems, etc.

Several attempts have been made to perform complex enterprise application processes on mobile devices. One approach is directed to synchronizing data directly with the backend enterprise systems on a per record basis (i.e., one-record-at-a-time). This approach suffers from several drawbacks, including (a) long synchronization times adversely impacting user productivity, (b) complex time-consuming and expensive system setup to control the data sent to the devices, and (c) high occurrence of conflicts for changes made in more than one place at one time reducing user productivity. With this approach, data synchronization is frequently, but not exclusively, performed on a backend-system-specific basis.

Another approach entails providing an offline storage (also referred to as the HTML5 storage) with a “mash-up” Web application. HTML5 refers to the fifth revision of the HyperText Markup Language (HTML) standard of a markup language used for structuring and presenting content for the World Wide Web (“Web”). HTML5 provides an application caching mechanism that allows Web applications to work while offline—users can still access and use them without any network connectivity. This “Web Application Offline Storage” approach also suffers from several drawbacks, including (a) considerably degraded user performance and (b) tight limits on the amount of data that can be stored efficiently, hence limiting the nature of the tasks that can be performed on the mobile devices.

In view of the drawbacks exemplified in these prior approaches, there is room for innovations and improvements.

### SUMMARY OF THE DISCLOSURE

Embodiments disclosed herein provide a new solution for performing processes on mobile devices, seamlessly integrating disparate mobile devices and complex enterprise systems.

To make it possible to perform reasonably complex enterprise processes on mobile devices, it is necessary to:
Identify the information needed on a certain mobile device to support a particular process of an enterprise system or systems.
Get that information to the mobile device rapidly and efficiently (perhaps faster than the enterprise system itself is able to support) so as to not interfere with the schedule of the mobile user.
Consolidate information from many backend enterprise systems (as dictated by the particular process) and send the consolidated information to the mobile device in an integrated manner.
Process data changes made by a user on the mobile device to the appropriate backend enterprise system(s), taking special steps to minimize the occurrence of conflicts and corruptions.

Embodiments disclosed herein provide many features that can address these issues, including, but are not limited to:
A flexible, adaptive canonical data model (CDM) for a common way to reference information across disparate backend enterprise systems and allow the system to work with any type of enterprise information—data and files.
Intelligent subscriptions for mapping hierarchies of this canonically defined information (which may span across enterprise backend systems), directly encapsulating all data dependencies to complete a process that can span many backend enterprise systems.
Individualized subscription rules and subscription views for determining which subscription hierarchies are sent to which devices owned by which individuals, in a manner that allows control of information distributed from many backend enterprise systems.
End user configurable default system behavior. End users can now override the default system behavior for information synchronized to their devices, while still benefiting from automatic synchronization of the majority case for what they will want and need.
A centralized “subscribed object mobile data cache” data storage on the server side for storing all information being sent to any user device, organized and stored in a device-friendly format to permit high-performance synchronization from this centralized data storage.
Continuous backend system monitoring for updated information so that device synchronization can be served entirely from the centralized “subscribed object mobile data cache” data storage on the server side. Backend enterprise systems are continuously and regularly checked for updated data, and changes from “pushed” from backends are regularly accepted, evaluated, and applied.
Field-level synchronization for getting updates from the mobile devices, enrich them with information maintained in the “subscribed object mobile data cache” data storage, and forward them to the respective backend enterprise system(s) for final handling in a parallel (many-at-once) pattern driven by a “dependency map” based on the type of action and the canonical data model.

One embodiment comprises a method for performing complex enterprise application processes on mobile devices utilizing one or more of the features disclosed herein. Another embodiment comprises a computer program product. The computer program product includes at least one non-transitory computer-readable storage medium storing computer instructions that are executable by a processor to perform the method. Yet another embodiment comprises a system having at least one processor and a memory storing computer instructions that are executable by the at least one processor to perform the method.

Numerous other embodiments are also possible.

Embodiments can provide many advantages. For example, embodiments can store and send information in a “subscription” format, permitting much faster and more efficient synchronization operations (whole and differential) than previous solutions, which store information in standard “normalized” formats. Preparing information in the background ahead of time can reduce the number of steps and application programming interface (API) calls involved for device synchronization. Specifically, in order to obtain information from a backend system using a normalized format it is classically necessary to execute one query per object per context. For example, obtaining a list of accounts and the people associated with those accounts would mean one query for the accounts, then one additional query per account for the people associated to that account. In practice this can result in 1,000's to 10,000's of system queries to perform a synch operation against the “normalized” backend format, where this can be accomplished with a single query using the “subscription” format. Here, an “account” is a non-limiting example type of information, data object or structure. Embodiments disclosed herein can be adapted for any type of data object or structure in any enterprise system.

Additionally, embodiments can control information sent to a remote client device in accordance with a “subscription” pattern, sorting out all required dependent data to perform a particular task remotely, avoiding the “gotcha” cases that complicate previous solutions. Further, embodiments can minimize the manual administration required by prior solutions by deferring to existing backend enterprise systems and operations to decide what information to send to the remote (external) backend enterprise systems. Moreover, embodiments can support overlapping and overlaying “subscription” patterns, sending devices a constructive union of the information specified. Also, embodiments can proactively monitor multiple backend enterprise systems for updated information, permitting all client device synch operations to be done entirely from the “subscribed object mobile data cache” data store. Furthermore, embodiments can process changes coming from remote client devices at a field level (rather than at a record level) to minimize the occurrence of conflicts that would otherwise force end users to re-do their work.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of a mobile framework server operating in a network computing environment;

FIG. 2 depicts a diagrammatic representation of an example embodiment of a mobile framework server;

FIG. 3A depicts a diagrammatic representation of one example of a CDM according to some embodiments;

FIG. 3B depicts a diagrammatic representation of another example of a CDM according to some embodiments;

FIG. 4 depicts a diagrammatic representation of one example of a subscription hierarchy according to some embodiments;

FIG. 5 depicts a diagrammatic representation of one example of the relationships between CDM objects according to some embodiments;

FIG. 6 depicts one example of a system logic diagram according to some embodiments;

FIG. 7 depicts a diagrammatic representation of one example of a subscription hierarchy, CDM objects, and subscription data stored in a data storage of a mobile framework server relative to enterprise data of backend enterprise systems;

FIG. 8 depicts a diagrammatic representation of one example of how subscription data in a subscription hierarchy may relate to enterprise data residing on completely different enterprise systems, each hosting its own information, with no particular relationship or bridge between them;

FIG. 9 is a flow chart illustrating an example of system operation according to some embodiments;

FIGS. 10-12 illustrate example subscriptions associated with a user according to some embodiments;

FIG. 13 depicts a diagrammatic representation of one example of how embodiments can significantly improve the performance of a mobile framework server;

FIG. 14 depicts a diagrammatic representation of one example of a process flow for up-synching; and

FIG. 15 depicts a diagrammatic representation of one example of data synchronization according to some embodiments.

### DETAILED DESCRIPTION

The invention and the various features and advantageous details thereof are explained more fully with reference to the non-limiting embodiments that are illustrated in the accompanying drawings and detailed in the following description. Descriptions of well-known processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As described above, prior approaches to performing complex enterprise application processes on mobile devices suffer several drawbacks particularly with respect to data synchronization. One reason is that a user may need a significant amount of data downloaded and synchronized (referred to herein as down-sync) from various disparate backend enterprise systems onto their mobile device in order to perform a material portion of their job on the road. For example, a service representative may need to down-sync all the active accounts that he is servicing onto his mobile device when he can reliably connect to the backend enterprise systems (e.g., using a network at his office or at a hotel). This way, he can take his mobile device and work offline and does not need to be concerned with network connectivity. However, this may mean that, for each active account, he may need to down-sync various types of account-specific information such as order history, contracts, recent account activities, contacts, service cases, assets, etc. For each type of account-specific information, multiple records may need to be pulled and down-synced. For instance, pulling an order history may require pulling a plurality of order items (order records), pulling each contract may require pulling files and/or records containing contract details, pulling contacts may include pulling each contact's recent activities, pulling service cases may entail pulling files and/or records containing case details, pulling assets records may include pulling files and/or records containing asset details, etc. These may be stored in different backend enterprise systems which may require additional access time. Likewise, a sales representative may need to pull up all the sales opportunities and each sales opportunity may require additional, various types of records such as proposed products, sales quotes, quote items, collaboration records, recent activities, sales team, discount approvals, etc. Depending upon network connectivity and speed, it can be as slow as one record per second to pull and down-sync all the data from the backend enterprise systems to a mobile device. Suppose tens or hundreds of thousands of records are needed on a mobile device, moving data at the current speed of tens of records per second means that a salesperson may spend twenty to thirty minutes somewhere waiting for their mobile device to be loaded with the information needed to do a job. Their time lost in waiting and hence the reduction in productivity can quickly add up. The terms “down-sync” and “up-sync” are used herein to specifically refer to two types of data synchronizations between backend enterprise systems and mobile devices.

Some CRM systems limit the amount of data that can be synchronized and stored on a mobile device. While this may shortened the amount of time needed for synchronization, it may suffer from incomplete and/or incorrect data being down-synced onto and/or updated on the mobile device.

The speed performance with respect to data synchronization between backend enterprise systems and mobile devices has long been an issue not only for down-syncing data from backend enterprise systems but also for up-syncing data to backend enterprise systems. For the latter, however, additional issues exist. For example, once the work is completed, a sales or service representative may go to a place where their mobile device can get a network connection and start uploading and synchronizing (referred to herein as up-syncing) what they have done to complete the work back to a backend enterprise system. There are many things that can go wrong during up-syncing. For instance, the sales or service representative may have performed a number of items (e.g., actions taken, part(s) ordered, quote(s) given, etc.) in order to complete the work and may have incorrectly entered one or more of those items. Alternatively or additionally, while he was offline in doing the work, someone may change the same item (e.g., one service representative reports that a gear is broken and another service representative reports that the same gear works just fine), causing a conflict in the enterprise system. The enterprise system generally takes the items one at a time which can take a long time; and, when anything goes wrong (e.g., an item was not keyed in correctly), either skips that item entirely or stops the synchronization altogether until that one item is fixed.

To address these and other issues related to data synchronization between disparate backend enterprise systems and mobile devices, embodiments disclosed herein provide a mobile framework server that can better handle the down-sync and up-sync operations and significantly improve the speed as well as the size of data that can be moved to and from backend enterprise systems and to and from mobile devices. For example, in some embodiments, millions of records may be down-synced to a mobile device at thousands of records per second. Additionally, the mobile framework server may provide a plurality of data services for handling network connectivity issues, recovering data without loss or duplication, detecting and resolving synchronization conflict and failure, and so on to thereby provide consistent, accurate, reliable, efficient, and effective results to backend enterprise systems as well as mobile devices.

Specific embodiments of a mobile framework server will be described in detail below. Those skilled in the art will appreciate that these embodiments are meant to be illustrative and non-limiting and that other embodiments may also be implemented or otherwise adapted.

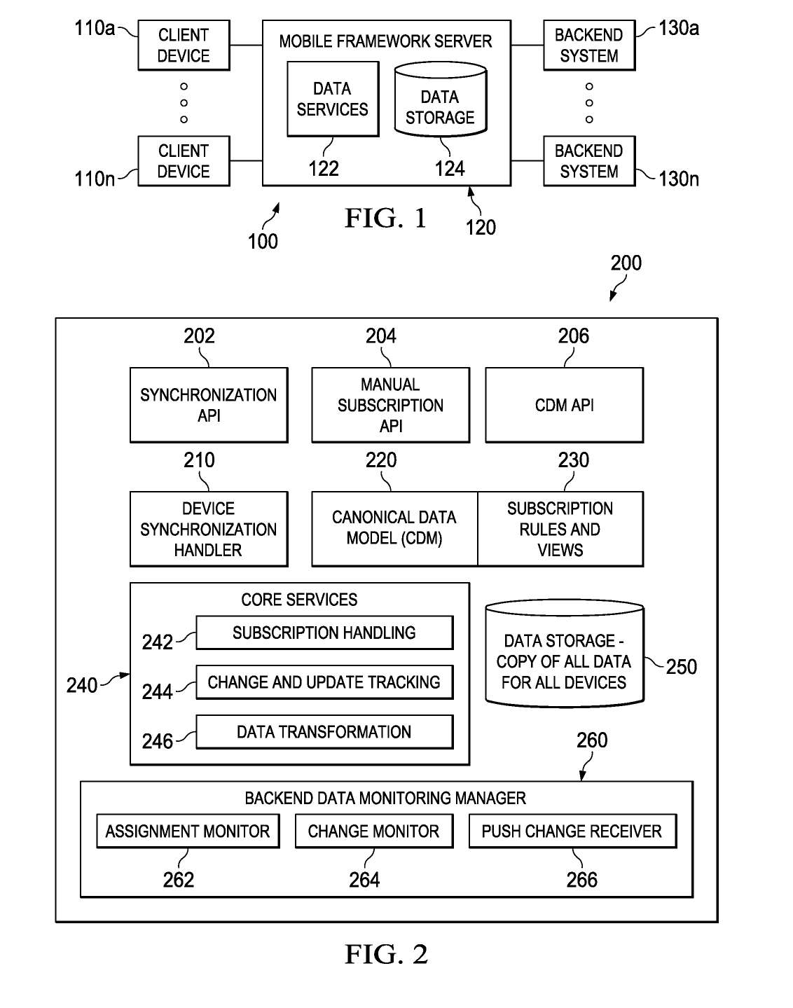

FIG. 1 depicts a diagrammatic representation of mobile framework server (MFS) 120 operating in network computing environment 100. MFS 120 may be communicatively connected to a plurality of client devices 110a . . . 110n, which may include different types of mobile devices, and to a plurality of backend systems 130a . . . 130n, which may include various disparate backend enterprise systems. Examples of client devices may include, but are not limited to, mobile devices, wireless devices, laptops, smart phones, tablet computers, handheld computing devices, digital personal assistant devices, etc. Examples of backend enterprise systems may include, but are not limited to, enterprise resource planning (ERP) systems, customer relationship management (CRM) systems, etc. Each enterprise system may comprise a plurality of computer systems running enterprise software on an enterprise platform to control all phases of an enterprise's operations to facilitate cooperation and coordination of work across the enterprise. In this disclosure, an enterprise platform refers to a set of computing and networking resources which enable the enterprise software to integrate core business processes (e.g., sales, services, accounting, finance, human resources, inventory, customer support, manufacturing, etc.) and may link suppliers, business partners, and customers of the enterprise. As such, enterprise systems are designed to manage large volumes of critical data at the server side, rather than managing the needs of mobile users.

Unlike prior approaches described above, client devices 110a . . . 110n associated with mobile users do not connect directly to backend systems 130a . . . 130n. Rather, client devices 110a . . . 110n connect to backend systems 130a . . . 130n via MFS 120. As shown in FIG. 1, MFS 120 include two main components—data services 122 and data storage 124. Examples of these and other components of MFS 120 are further described below.

FIG. 2 depicts a diagrammatic representation of mobile framework server (MFS) 200 implementing an embodiment of MFS 120 described above. In this example, MFS 200 may comprise an application programming interface (API) layer, a processing layer, a modeling layer, a services layer, a storage layer, and a backend monitoring layer. The API layer may include synchronization API 202, manual subscription API 204, and canonical data model (CDM) API 206 configured for communicating with various client devices at the front end (e.g., client devices 110a . . . 110n shown in FIG. 1). In some embodiments, each client device may have a synch manager that can communicate with MFS 200 via these APIs. The synch manager on the client device may keep track of user actions (e.g., interactions with a client application of MFS 200 running on the client device), store associated information in a device data store on the client device, and maintain a pending synch log on the client device. The programming techniques and resources necessary to implement such a synch manager on the client device are known to those skilled in the art and thus are not further described herein.

The processing layer implemented on MFS 200 may include device synchronization handler 210 configured for generating and processing dependency maps between and among the changes performed by the user when offline. In some embodiments, a dependent map may be created based on information (a synch log file) received from a client device. The creation, processing, and utility of a dependency map are further described below.

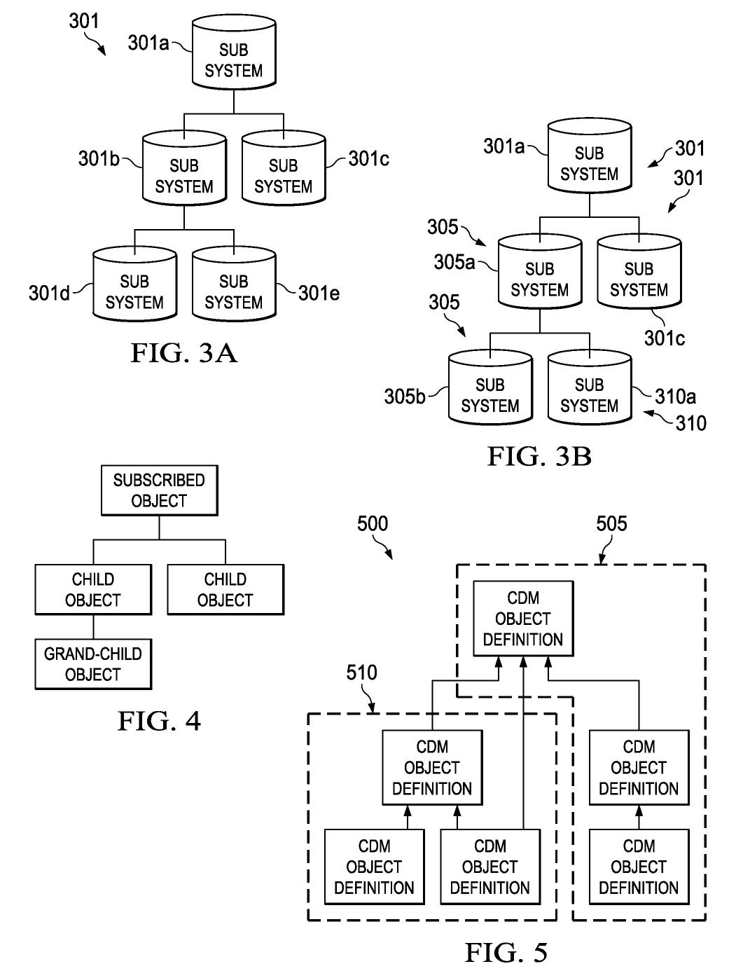

The modeling layer implemented on MFS 200 may include CDM 220 implementing subscription rules and views 230. CDM 220 may comprise backend source data modeling patterns and may support a single backend enterprise system (e.g., backend system 301 with subsystems 301-301e shown in FIG. 3A) or multiple backend enterprise systems (e.g., backend system 301 with subsystems 301a, 301c, backend system 305 with subsystems 305a, 305b, and backend system 310 with subsystem 310a shown in FIG. 3B). As explained below, CDM 220 may provide a roadmap for MFS 200 to manage retrieving the needed data of various formats from one or more involved enterprise systems at the backend and generating corresponding views for the appropriate users in accordance with a set of subscription rules.

At this time, it might be helpful to explain some terms disclosed herein:

Subscribed objects—objects at the top level of a subscription hierarchy that a user would understand and want information about (e.g., “accounts” or “opportunities”). An example of a subscription hierarchy is depicted in FIG. 4. As discussed above, an “account” is used herein as a non-limiting example type of information, data object or structure. Embodiments disclosed herein can be adapted for any type of data object or structure in any enterprise system.

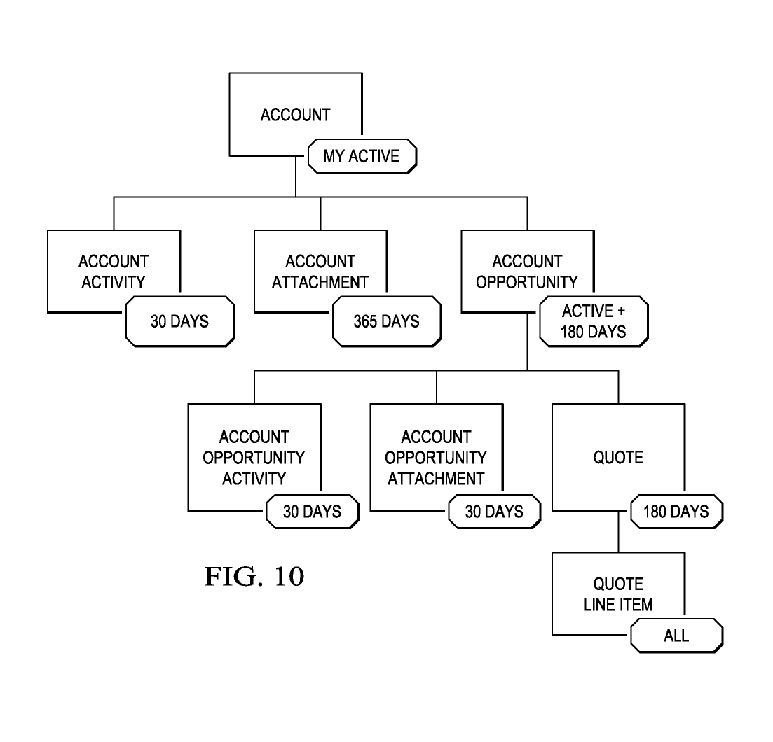

Subscription rules—rules that define an initial set of records that a user has subscribed to synchronize (e.g., “my active accounts” shown in FIG. 10).

Subscription rule overrides—settings that can be configured by a user to handle scenarios when a subscribed object record (and child objects) is to explicitly added or removed from the user's device.

Subscription criteria—criteria that define a subset of records in the child objects (e.g., “all incomplete activities and all complete activities less than 30 days old.”).

Overlapping subscriptions—subscriptions that are duplicative in nature and that are needed at different levels of a subscription hierarchy. For example, a service technician may need service instructions for servicing two different models of a particular computer. Both models may have the same service instructions from the manufacturer. In this case, individual records are handled on “union” basis where they are sent once. That is, the same child object (the service instructions) would have two different parent objects (computer models). The child object is removed only when not needed by any subscribed object parent.

In some embodiments, a CDM may define the objects and the relationships there-between (e.g., CDM 500 shown in FIG. 5) while subscription hierarchies define subsets of the CDM for subscription rules and synchronization to client devices (e.g., subscription hierarchies 505, 510).

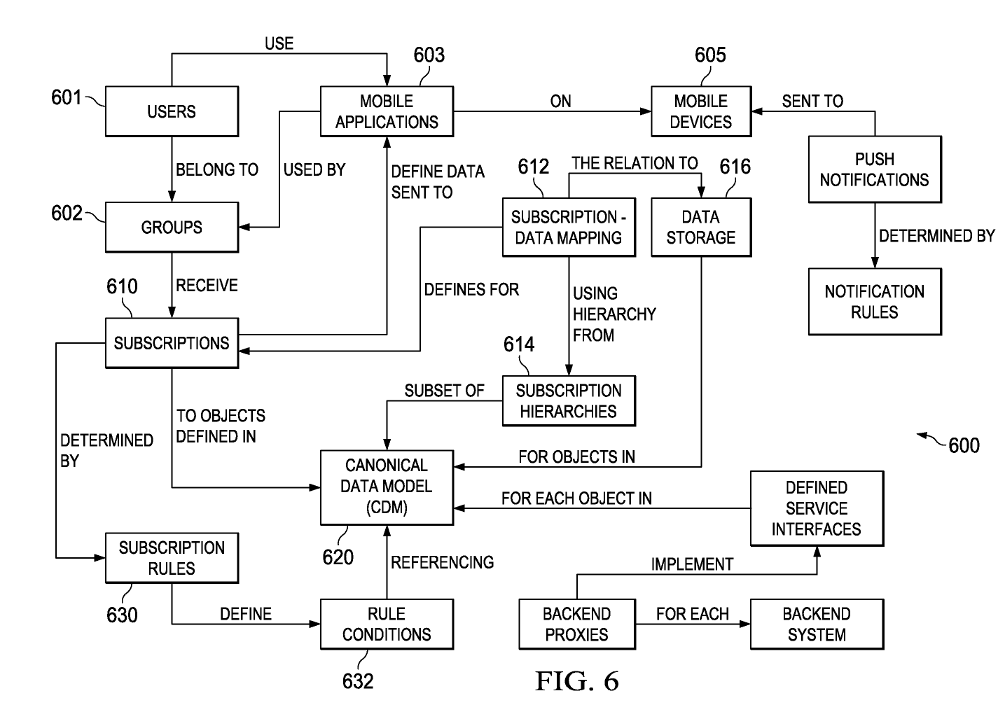

Within this disclosure, a CDM is considered a building block for understanding the data elements and the dependencies between the data elements. To this end, the multiple subscription hierarchies in the CDM are set up as configurations and not as programming. The CDM helps the underlying system (e.g., MFS 200 shown in FIG. 2) to understand that set up and what appropriate actions need to be taken against multiple backend enterprise systems. This is further illustrated in system logic diagram 600 shown in FIG. 6.

System logic diagram 600 is a relationship map (e.g., belongs to, used by, determined by, etc.) that illustrates by example the logical structures inside a system implementing an embodiment of a MFS disclosed herein. It shows how subscription management can be performed (via subscription components 610, 614, 620, 630, 632) and how all the relationships can be maintained without relying on programming for each subscriber.

As a non-limiting example, user 601 may belong to group 602 set to receive one or more subscriptions 610 via mobile application 603 running on mobile device 605. In this example, each “user” would be a record in a group (e.g., services reps, sales reps, sales managers, etc.). Subscriptions 610 for each user or group may be defined by subscription rules 630. Subscription rules 630 have rule conditions 632 that reference CDM 620. Subscription-data mapping 612, which may be stored in data storage 616, may be determined using subscription hierarchies 614 which, as explained above, are subsets of CDM 620.

Returning to FIG. 2, the services layer implemented on MFS 200 may include core services 240 such as subscription handling service 242, change and update tracking service 244, and data transformation service 246. These services can handle a variety of issues common in prior approaches, including:

Long synch time: To address this issue, data is pre-emptively loaded and categorized into a subscription format; actions from remote client devices are consolidated, reducing interactions with the backend; and only data where “mobile relevant” field updates are made are sent to the client devices.

Many synch failures: To address this issue, field-level synchronization, rather than record-level synchronization, is used to reduce the chances of user-driven update conflicts and especially interface-driven “record version number” conflicts.

High initial configuration cost: To address this issue, an intelligent subscription model is used to avoid the “gotcha” cases that demanded time consuming and expensive expert services work. A straightforward XML and GUI configuration process is used.

High ongoing management cost: To address this issue, manual overrides of default system behavior are put in the user's hands, eliminating the need to rely on administrators. Default system behavior can be driven by updates being made to the backend enterprise systems.

Additionally, these services can handle a variety of data operations, including:

Major updates (for example, annual price list update, territory re-alignment, return from leave, etc.): To handle this type of operation, a series of synch operations are performed back to back to completion.

Initial extraction (for example, new system install, new user, new device, recover from lost device, etc.): To handle this type of operation, a series of synch operations are performed back to back to completion. Further, a SQLite database may be created on the server and shipped to client device(s) when ready.

Secure data deletion (e.g., lost device, employee exit, etc.): To handle this type of operation, a manual ‘device wipe’ command is issued through push notifications (see, e.g., system logic diagram 600 shown in FIG. 6). In response, all device data is deleted (e.g., by mobile application 603 shown in FIG. 6) and all subsequent updates are rejected.

Excess time since last synch: As a security feature, access to enterprise data on a client device may be blocked (e.g., by mobile application 603 shown in FIG. 6) until the client device is synched again.

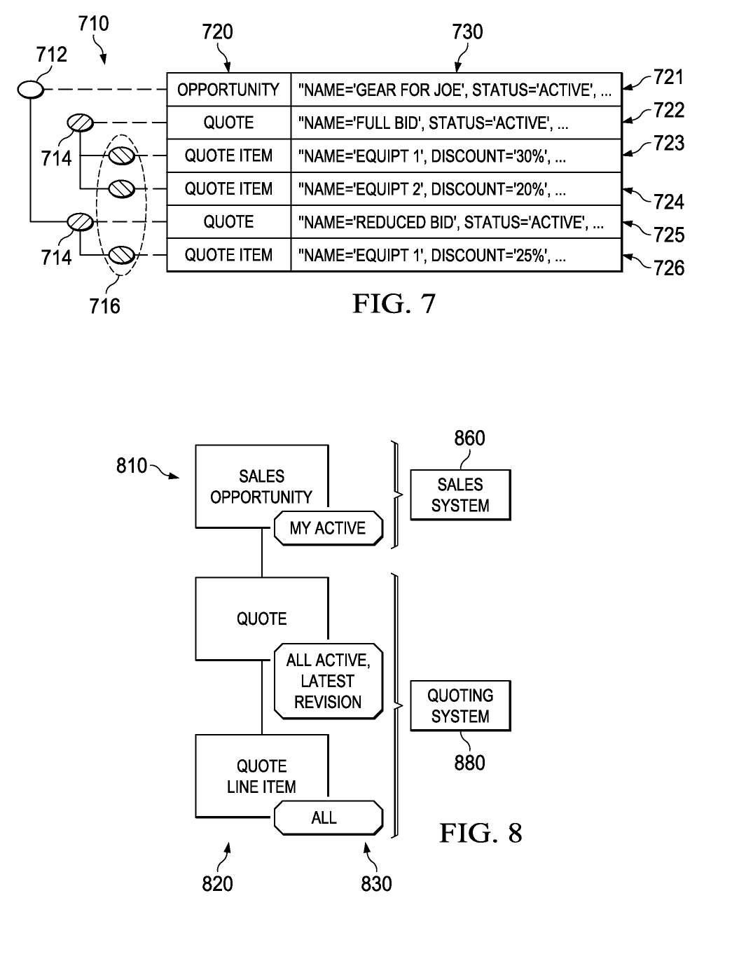

To reduce sync time, enterprise data is preemptively loaded from appropriate backend enterprise system(s), transformed into a subscription format (subscription data), and stored in data storage 250 at the storage layer implemented on MFS 200. As illustrated in FIG. 7, subscription data stored in data storage 250 can tie each record (row) of enterprise data directly to a subscription (which was created as an entity) in a subscription hierarchy, without intermediate levels of hierarchy. For example, in FIG. 7, record 721 is directly associated with subscription 712 in subscription hierarchy 710; each of records 722 and 725 is directly associated with subscription 714; and each of records 723, 724, and 726 is directly associated with subscription 716.

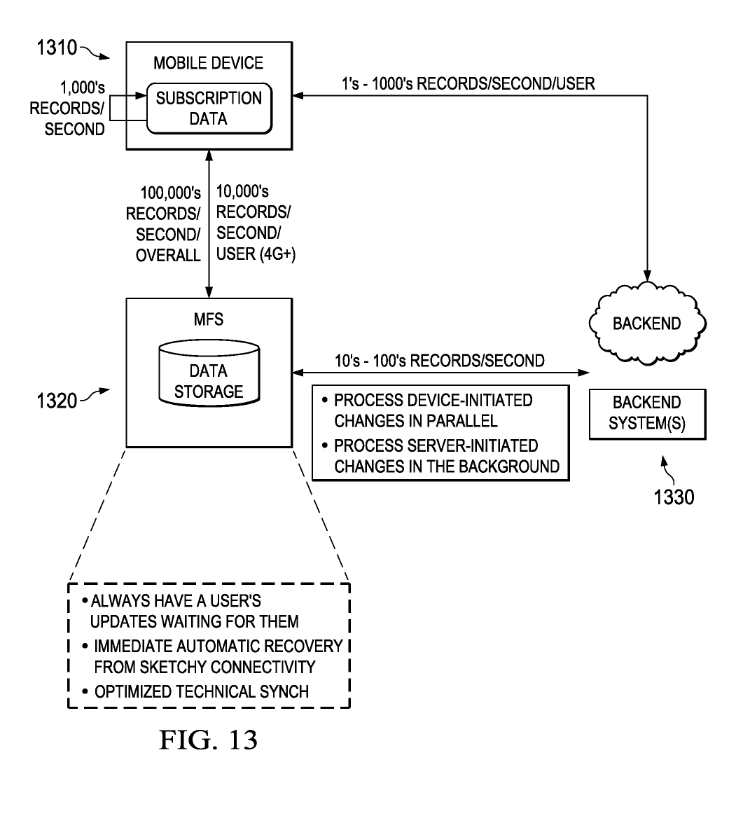

Although referred to above as “records,” enterprise data is not stored on MFS 200 as database records. Rather, enterprise data is processed to determine what records are needed for what subscription and associated with appropriate CDM objects 720. CDM objects 720 may have various object types. Each CDM object type may define a particular list of data fields and data types. For example, an “opportunity” object may have a name field, a status field, etc., while a “quote Item” object may have a name field, a discount field, etc. Subscription data 730 is stored in an object-agnostic format, permitting the system (e.g., MFS 200 shown in FIG. 2) to handle any type and/or amount of data. In this way, MFS 200 may store a shadow, transformed copy of all the enterprise data that the client devices have subscribed to receive via services (e.g., core services 240) provided by MFS 200. The shadow copy of the enterprise data is continually maintained current in the background by MFS 200 so the most fresh, accurate data can be synchronized to client devices rapidly which, in some embodiments, can be faster than what would be provided by the backend enterprise systems (see, e.g., FIG. 13).

The enterprise data remains under the control of and is maintained by the enterprise system(s) at the backend. For example, referring to FIG. 8, sales system 860 and quoting system 880 may be two completely different enterprise systems, each hosting its own information, with no particular relationship or bridge between them. However, records can be retrieved from these disparate enterprise systems (e.g., via separate sales system connector and quoting system connector), transformed into CDM objects 820 (e.g., via data transformation service 246 shown in FIG. 2), loaded into CDM subscription hierarchy 810 (e.g., via subscription handling service 242 shown in FIG. 2) and tied to appropriate subscriptions 830 (e.g., via change and update tracking service 244 shown in FIG. 2) as described above. Implementations of backend enterprise system connectors are known to those skilled in the art and thus are not further described herein.

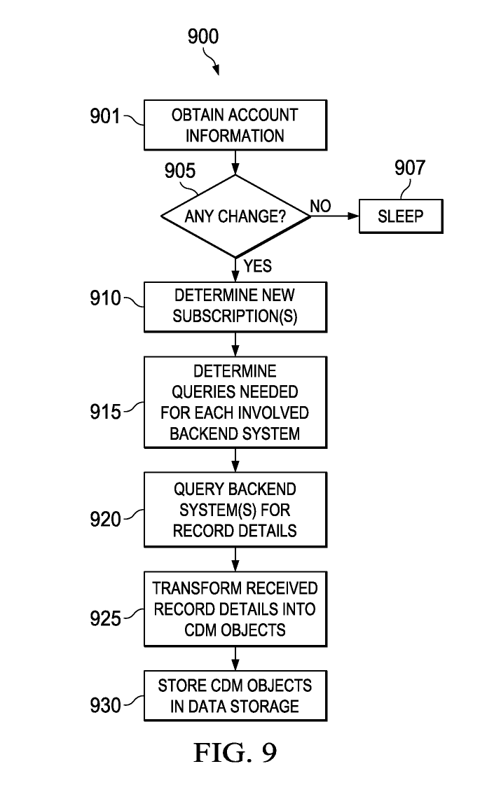

Continuing with FIG. 2, the backend monitoring layer implemented on MFS 200 may include backend data monitoring manager 260 configured with a plurality of functions such as assignment monitor 262, change monitor 264, and pushed change receiver 266 for monitoring as well as communicating (e.g., via appropriate enterprise system connectors) with disparate enterprise systems at the backend (e.g., backend systems 130a . . . 130n shown in FIG. 1). An example of how these functions operate in concert will now be described with reference to FIG. 9.

FIG. 9 is a flow chart illustrating an example of system operation 900. In some embodiments, a backend data monitoring manager (e.g., backend data monitoring manager 260 shown in FIG. 2) may implement a timing mechanism and, at a configurable time interval (e.g., every few minutes), wake up an assignment monitor (e.g., assignment monitor 262 shown in FIG. 2) to ping (901) a backend system (e.g., an ownership system that maintains user account information) to obtain account information of users who subscribed and/or are assigned to receive enterprise data through a mobile framework server (e.g., MFS 200 shown in FIG. 2). Specifically, the assignment monitor may send a list of user name(s) and/or identifier(s) to the backend system via a secure connection. The list of user name(s) and/or identifier(s) may be filtered according to field-level subscription rules and subscription criteria.

For each user, the backend system returns a list of active account numbers (e.g., ID values for the records maintained at the backend) currently assigned to or otherwise associated with the user name and/or identifier. The account information (which, at this point, consists of ID values only) is communicated to a change monitor (e.g., change monitor 264 shown in FIG. 2). For each user, the change monitor compares the account information from the backend system with a list of active accounts that the individual user has had before and determines whether there is a change (905). Note that the mobile framework server remains isolated from knowing how the backend system came up with the list of active account numbers.

If no change is detected for any of the listed user(s), system operation 900 goes back to the sleep mode (907). If a change is detected, the change is communicated to a subscription handling service (e.g., subscription handling service 242 shown in FIG. 2). The subscription handling service is operable to determine what has changed as efficiently as possible and decide if that change is relevant to a mobile user. If so, then the details are obtained (via a separate process). For example, it may be that a user had 10 accounts assigned to him and the most recent ping returns 11 accounts for the user. The subscription handling service may compare records obtained before and after the ping and recognize that the change is caused by a new account assigned to the user and, therefore, a new subscription is needed for the user (910).

As those skilled in the art can appreciate, a new account may be assigned to a user at a backend enterprise system for various reasons and entered either manually by an administrator or programmatically when a threshold (e.g., the number of sales representatives per a geographical area) is reached. In some embodiments, a backend enterprise system may push a change to the mobile framework server. Such a push can be handled by a push change receiver at the mobile framework server (e.g., push change receiver 266 shown in FIG. 2).

At this time, all the mobile framework server knows about the new subscription needed for the user is the new account number. In some embodiments, a change and update tracking service (e.g., change and update tracking 244 shown in FIG. 2) may consult a CDM (e.g., CDM 500 shown in FIG. 5) and subscription hierarchies (e.g., subscription hierarchies 505, 510 shown in FIG. 5) to determine record details (enterprise data) needed for the new subscription. For example, a CDM object in the CDM may have a CDM object definition that specifies what data fields should be in an account (e.g., it has a company name field, a street address field, a primary contact field, and so on). The record details may be stored at various repositories managed by one or more backend enterprise systems, as illustrated in FIGS. 3A and 3B. To this end, the change and update tracking service may determine what repository/repositories store the enterprise data associated with the fields, may determine appropriate queries particular to the repositories involved (915), and may call to the backend system(s) to request the enterprise data needed for the new account (920). For example, the change and update tracking service may determine a first query for obtaining all the details for the sale history associated with the new account from a sales system (e.g., sales system 860 shown in FIG. 8) and send the first query to the sales system and may also determine a second query for obtaining all the quotes associated with the new account from a quoting system (e.g., quoting system 880 shown in FIG. 8) and send the second query to the quoting system. As discussed above, these enterprise systems may be separate and independent of one another and, therefore, the sale history and quotes may be in different formats. In some embodiments, multiple records of the same type may be obtained in a single call (i.e., a bulk operation).

Record details received from the backend enterprise system(s) (which may be in disparate formats) are transformed, via a data transformation service (e.g., data transformation service 246 shown in FIG. 2), into CDM objects implementing the subscription format described above (925) and stored as subscription data in a data storage (e.g., data storage 250 shown in FIG. 2) local to the mobile framework server (930). At this point, the subscription data is ready for down-syncing to a client device associated with the user to which the new account is assigned.

The example of system operation 900 described above can be configured to perform continuously for each user subscribing to receive enterprise data via the mobile framework server. It works regardless of whether the user is online or offline. In some embodiments, certain subscription data may only be down-synced and restricted to temporary use when the user is online because it is sensitive, has credit card numbers, or otherwise has some information that is not meant to be persisted on a user device.

By constantly monitoring the backend enterprise systems and preparing the most up-to-date subscription data for down-syncing, when a user is ready to do a job (e.g., by logging on via mobile application 603 running on the user's mobile device 605 as shown in FIG. 6), the mobile framework server can send all the information the user needs to the user's mobile device. As illustrated in FIG. 10, if a user subscribes to receive data for all his active accounts, the user would receive all accounts where the Active flag is set. Each account may have a set of child objects based on subscription criteria (e.g., 30 days, 365 days, all, etc.). Such subscription criteria may be defined by one or more administrators of backend enterprise system(s). The children (child objects) defined by a subscription hierarchy (which types of children) would be provided to the user's device according to subscription rules (which records for each child object). The user does not receive all of his accounts (e.g., closed or inactive ones are excluded) and also does not receive the accounts that the user may have worked on but does not own. In the example of FIG. 3, the user receives all his active accounts that have been active within the last 30 days, all account attachments within the last 365 days, etc. However, these subscriptions could be broader or smaller.

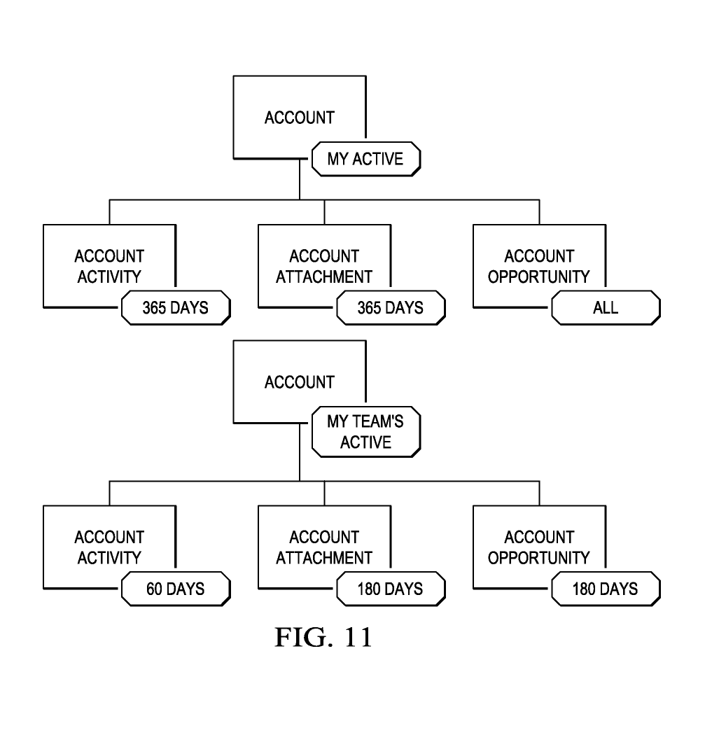

For example, as illustrated in FIG. 11, a user may receive a large amount of information for “My Accounts” that are active, and a medium amount of information for “My Team's Accounts” that are active. In this case, each account would be handled one way or another, based on a predetermined precedence (e.g., if an active account is both “mind” and “my teams,” it is treated like it is “mine.”).

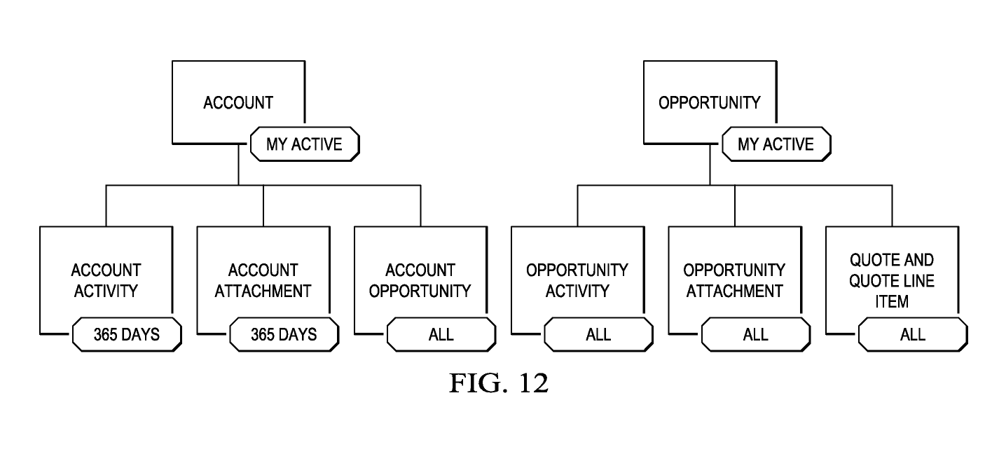

As another example is depicted in FIG. 12 in which a user may receive summary information about all the opportunities for all of their active accounts, plus detailed information about each opportunity that the user is actively working on. The user may manually subscribe and/or unsubscribe to either “Accounts” or “Opportunities.” This allows a precise tailoring of the amount of information sent to each user's device. Other combinations of subscriptions may also be possible.

In this way, the mobile framework server can intelligently and proactively determine what each user needs in order to do what job (assigned to the user). It can chase each backend enterprise system to get the enterprise data needed, chase each subscriber (enterprise user) to determine what they need—all these pieces of information require diligent investigation and follow-through, which is what makes conventional CRM systems slow. Embodiments of a mobile framework server disclosed herein can perform system operations such as system operation 900 described above ahead of time and store the needed subscription data for each user in the format that is ready to be down-synced to the user's mobile device. The mobile framework server can send all the information the user needs to the user's mobile device in a manner that is significantly faster than the mobile device having to separately synchronize with disparate backend enterprise systems. This is illustrated in FIG. 13.

MFS 1320 may determine and obtain the needed subscription data from backend system(s) 1330 (either initiated by mobile device 1310—see manual subscription described below—or initiated by MFS 1320) and send the subscription data to mobile device 1310 at a data rate of 10,000's or more records per second per user. By contrast, conventional systems gradually discover (at the backend) the information needed when requested in real time, at a data rate of 1's-100's records per second per user. For example, a user may request a service history and a conventional system would pull up the service history. Then, the user may request details for a gear and the conventional system would pull up the details for the gear. Next, the user may want to review old complaints for a customer and the conventional system would pull up the old complaints. Thus, conventional systems operate in a linear fashion driven by what a user needs and pulls what is needed one request at a time.

In the example described above, a new subscription may be proactively determined by a MFS and corresponding subscription data prepared automatically. In some embodiments, a new subscription may be manually added by a user. For example, a salesperson may want to look up and activate one of their inactive or dormant accounts and make a sales call at that account.

To do so, the salesperson may subscribe to receive, via the MFS, enterprise data associated with the inactive account via a mobile application (e.g., mobile application 603 shown in FIG. 6). The salesperson may only need to provide an account number to the MFS and the MFS would retrieve all the enterprise data needed for the new subscription as explained above, even if the enterprise data needed for the new subscription may be controlled and maintained by disparate backend enterprise systems. As another example, suppose the MFS checks for new accounts once a day and a user knows that he has been assigned a new account. In this case, the user can override the default system operation and force the MFS to check for new accounts. Such a client device initiated down-syncing operation may be processed in parallel with up-syncing to minimize synch time. As yet another example, one or more backend systems may also force the MFS to check for new accounts on-demand. For example, an event-driven mechanism implemented at a backend enterprise system may be utilized to notify the MFS to perform checks for backend changes. Thus, automated checks for backend data may be performed by the MFS either on-demand or at a time interval.

In some embodiments, subscription data may comprise actions that a user needs to perform for his work. A synch manager on the user's device may keep track of user actions (e.g., “check to see if a particular gear is operational,” “determine that the gear is broken,” “order a replacement gear,” etc.) in a pending synch log on the user's device. The user may perform his work while the device is offline. Once the work is complete, the user may wish to up-sync such offline actions with relevant enterprise system(s).

As discussed above with regard to prior approaches, when a client device attempts to sync with an enterprise system, the enterprise system generally takes the items one at a time which can take a long time; and, when anything goes wrong (e.g., an item was not keyed in correctly), the enterprise system may either skip that item entirely or stop the synchronization altogether until that one item is fixed (e.g., the sync stops whenever the enterprise system at the backend stops). Skipping a step may potentially create conflicts, due to the hierarchy of information. Following the above example, in order to repair a gear, the user may first investigate, then troubleshoot, then order a replacement part, etc. Suppose the first step is skipped due to a sync error, the user is essentially sending part requisitions or replacement part consumption notices for something that was not properly investigated according to the hierarchy of information. That will raise a number flags and/or other conflicts. For example, the user's company may not be able to bill their customer for the gear repair because the user did not do it in accordance with the contract between the company and their customer (e.g., first investigate, then troubleshoot, then order a replacement part, etc.). Additionally or alternatively, the enterprise system may determine, based on incomplete information from the sync operation which skipped the investigate step, that the user is trying to do maintenance on something that has not been installed and, consequently, start to issue failure notices. Administrator(s) then have to chase down on such failures and try to sort things out one at a time at considerable cost and delay to business operations.

Stopping the synchronization altogether has its own drawbacks. For example, suppose a user arrived at a customer site, investigated a problem and performed 100 other actions, and attempted to an update to an enterprise system at the backend that says he has investigated the problem. Unfortunately, the sync fails at the first step and the enterprise system stopped the sync operation, so none of the other 100 things that the user did are sent while the user tries to deal with the sync failure. In the meantime, the user may not get the work credit for all the other 100 things that he did; his company can't send a bill to the customer; and if another service person is to come and try to fix the gear, that person will not see the 100 things that the user did, since none of them got sent to the enterprise system at the backend. Again, this would involve an administrator to try to override, etc.

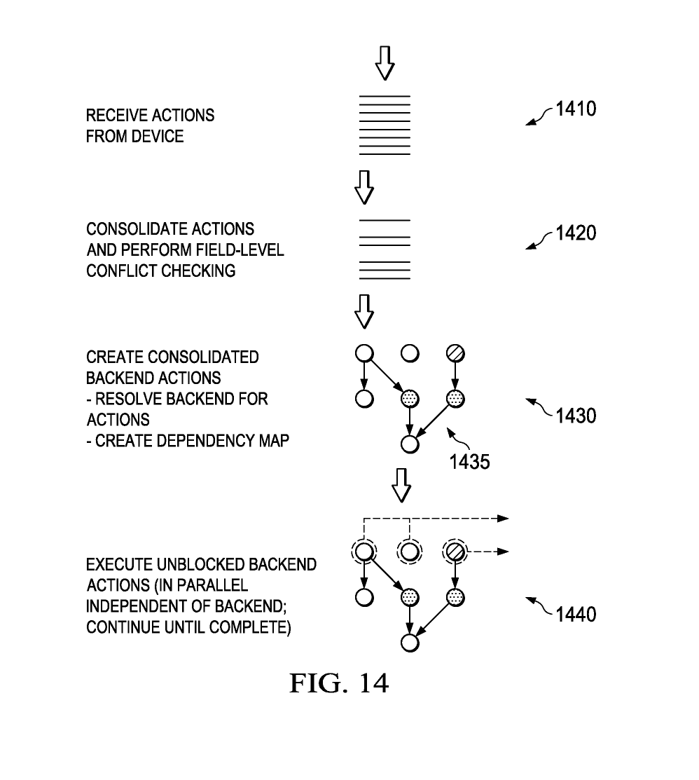

To overcome these and other common drawbacks of conventional systems, embodiments of an MFS disclosed herein are configured with the intelligence to determine what (offline) user actions are related and, therefore, should be up-synced together (referred to herein as connected actions). Specifically, as illustrated in FIG. 14, an MFS may receive (e.g., from a synch manager operating on a user's mobile device) a pending synch log containing a list of user actions recorded on the device (1410). The MFS may take these actions, strip out conflicting and contradictory actions, and eliminate unnecessary actions and any field-level conflicts (1420). Since the MFS keeps track of changes, it knows what has been changed. Accordingly, it can consolidate those actions and send only necessary updates to the backend. This can be done by analyzing the actions received from the user's device based on how the user's subscriptions are defined and what actions the user has taken relative to the user's subscriptions.

To create consolidated backend actions, the MFS may determine what actions should be connected and create a dependency map (e.g., dependency map 1435 shown in FIG. 14) out of such connected actions (1430). The dependency map defines how an action or actions may depend on another in terms of the transactions that have to be performed upon the backends. The MFS then processes the dependency map and sends the consolidated backend actions accordingly (1440). Should a backend system fail or reject a transaction for any reason, the actions dependent upon the failed or rejected action will be skipped so as to avoid data corruption or unintended consequences and the mobile device user so informed, whereupon they can make corrections, re-submit, or discard at their discretion.

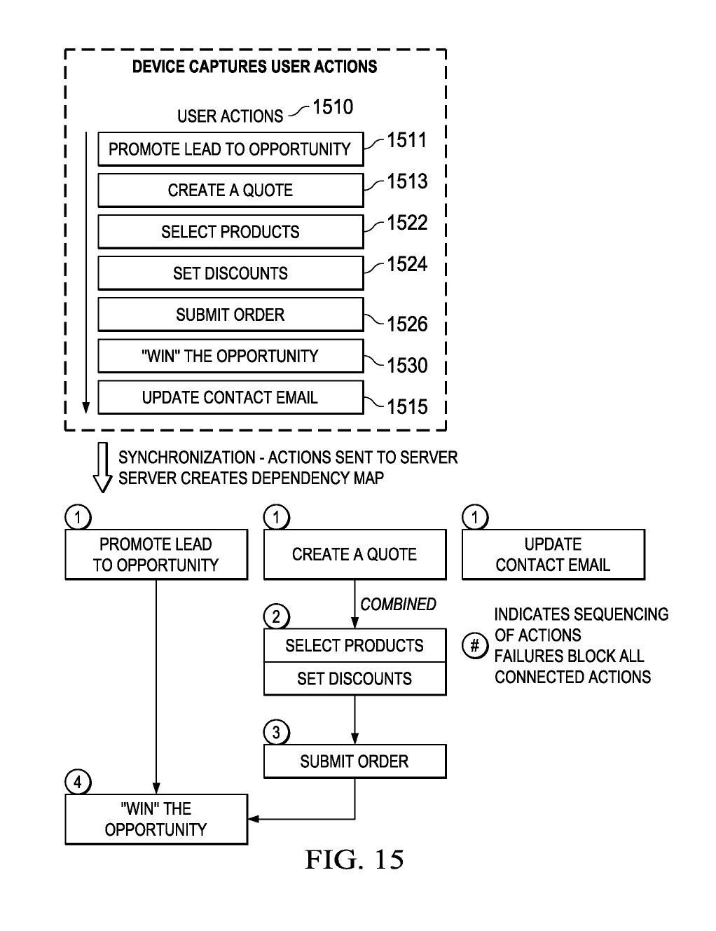

Unlike prior systems which process actions sequentially, the MFS performs a lot of parallel processing to significantly improve the speed of the MFS. This is possible because the dependency map allows the MFS to understand where the relationships are. For example, if there is a problem synchronizing something related to a piece of gear, the MFS does not skip just the action related to the piece of gear—it skips all the subsequent actions connected to the piece of gear. However, it does not stop the synchronization altogether. Rather, it will continue to synchronize all the other actions that the user did for the other piece of gear just fine because, according to the dependency map, these two pieces do not depend on each other. This is further illustrated in FIG. 15.

In the example of FIG. 15, a MFS may receive user actions 1510 from a user's mobile device. User actions 1510 may include a list of actions that the user has performed, including actions 1511, 1513, 1522, 1524, 1526, 1530, 1515, etc. In some embodiments, a sync manager running on the user's mobile device may track all the data changes that the user makes on their mobile device, which is different from tracking all the records that they touched. Specifically, the sync manager may track all of the user's actions/interactions with a mobile app (e.g., every time they update something, every time they submit something, every time they touch a button to attach a picture, every time they fill out a form, every time they mark something completed, etc.). All of these actions are captured and stored in a pending sync log file. From the perspective of the user's mobile device, all it needs to do for up-syncing is to send the pending sync log file to the MFS. It does not need to communicate with disparate enterprise systems and risk the various sync issues and problems common in the prior approaches described above. Such a streamlined operation at the device side can significantly improve the performances (speed, reliability, consumption of computational resources, etc.) of the user's mobile device.

The pending sync log file may contain certain user actions that do not amount to actual updates that should be provided to backend enterprise system(s). For instance, a user may mark a job done, then cancels it (thinking that it was premature), does some other action(s), and then marks it done again. The MFS does not need to send the older “done” and “undone” actions. These actions are time-stamped in the pending sync log file, so the MFS knows the sequence of the actions and only needs to process the last “done” action. This allows the MFS to remove noises and consolidate actions where appropriate. For example, the user may first mark the “done” action at 12:01 PM, then changed it to “undone” at 12:03 PM, then made a call at 12:04 PM (perhaps to consult with a tech support), and marked it “done” again at 12:07 PM. By analyzing these actions relative to time, the MFS can take the last “done” action at 12:07 PM and ignore the first “done” action at 12:01 PM. This consolidation process could be done by event type, so the call event is not ignored, but the redundant “done” action at 12:01 PM and the subsequent “undone” action at 12:03 PM are eliminated.

The MFS may determine what actions should be connected in terms of transaction that has to happen in the backend and create a dependency map. In this case, the MFS may determine that actions 1511, 1513, and 1515 do not depend on any other action and, therefore, can be processed in parallel. This is shown as the first sequencing of actions in FIG. 15. Each such unblocked action may have zero or more blocked actions connected thereto. Each blocked action may, directly or indirectly, depend on one or more unblocked actions. For example, blocked action 1530 may be directly connected to unblocked action 1511 and also indirectly to unblocked action 1513, via intermediate blocked actions 1522, 1524, and 1526. As shown in FIG. 15, some unblocked actions may be combined (e.g., actions 1522 and 1524). In this example, unblocked action 1515 does not have any connected actions. Suppose the sync operation (between the MFS and a backend enterprise system) fails to send unblocked action 1511, the sync operations for unblocked actions 1513 and 1515 are not affected. The MFS will continue to process blocked actions 1522, 1524, 1526, and 1530 and send them to appropriate backend enterprise systems. The backend enterprise systems then update their records to reflect the particular actions taken by the user. When the sync failure is resolved, the MFS sends unblocked action 1511. However, since connected action 1530 had been sent in a separate process, the MFS may not need to send it again.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A method of data synchronization, comprising:
at a mobile framework server having a central data storage, at least one processor, and non-transitory computer memory including instructions translatable by the at least one processor to perform a default system operation including:
obtaining, periodically from a first backend enterprise system, data object information for a user who subscribed or is assigned to receive enterprise data via the mobile framework server;
determining that the data object information indicates a change in data object records assigned to or associated with the user;
determining that the change is associated with a new data object record;
determining that a new subscription is needed for the new data object record;
determining a plurality of fields for the new data object record using a canonical data model (CDM), wherein each CDM object in the CDM includes a CDM object definition specifying a set of data fields particular to the CDM object;
determining where enterprise data for the plurality of fields is stored;
determining queries for obtaining the enterprise data from one or more backend enterprise systems;
querying the one or more backend enterprise systems using the determined queries;
transforming the enterprise data received from the one or more backend enterprise systems into subscription data in a subscription format;
storing the subscription data in the central data storage; and
sending the subscription data to a mobile device associated with the user.

2. The method according to claim 1, further comprising:
receiving, from the mobile device, a pending sync log file containing user actions performed within a period of time;
consolidating the user actions;
removing any field-level conflicts;
creating consolidated backend actions, comprising:
determining which of the user actions are unblocked actions;
determining if any set of actions are combinable;
for each of the unblocked actions, determining if any blocked action is connected thereto;
creating a dependency map based on relationships between the user actions thus determined;
sending the consolidated backend actions to the one or more backend enterprise systems based on the dependency map.

3. The method according to claim 2, wherein the unblocked actions are sent to the one or more backend enterprise systems in parallel.

4. The method according to claim 2, further comprising:
for a sync failure associated with a first unblocked action, skipping the first unblocked action and any blocked action connected thereto; and
continually processing at least a second unblocked action of the unblocked actions.

5. The method according to claim 1, further comprising:
responsive to a request from the mobile device or a notice from a backend enterprise system, overriding the default system operation, dynamically adding a second new subscription for the use, obtaining record details associated with the second new subscription, transforming the record details into new subscription data, and sending the new subscription data to the mobile device.

6. The method according to claim 1, wherein the user is one of a plurality of users on a list prepared by the mobile framework server based on subscription rules and sent to the first backend enterprise system.

7. The method according to claim 1, wherein the CDM comprises subscription hierarchies, each subscription hierarchy containing a set of subscriptions, wherein each CDM object is directly associated with a subscription, and wherein the subscription format is an object-agnostic format.

8. A system for data synchronization, comprising:
a mobile framework server having a central data storage, at least one processor, and non-transitory computer memory including instructions translatable by the at least one processor to perform a default system operation including:
obtaining, periodically from a first backend enterprise system, data object information for a user who subscribed or is assigned to receive enterprise data via the mobile framework server;
determining that the data object information indicates a change in data object records assigned to or associated with the user;
determining that the change is associated with a new data object record;
determining that a new subscription is needed for the new data object record;
determining a plurality of fields for the new data object record using a canonical data model (CDM), wherein each CDM object in the CDM includes a CDM object definition specifying a set of data fields particular to the CDM object;
determining where enterprise data for the plurality of fields is stored;
determining queries for obtaining the enterprise data from one or more backend enterprise systems;
querying the one or more backend enterprise systems using the determined queries;
transforming the enterprise data received from the one or more backend enterprise systems into subscription data in a subscription format; and
storing the subscription data in the central data storage; and
a mobile framework application running on a mobile device associated with the user, the mobile framework application configured to receive the subscription data from the mobile framework server.

9. The system of claim 8, wherein the mobile framework server is further operable to perform:
receiving, from the mobile device, a pending sync log file containing user actions performed within a period of time;
consolidating the user actions;
removing any field-level conflicts;
creating consolidated backend actions, comprising:
determining which of the user actions are unblocked actions;
determining if any set of actions are combinable;
for each of the unblocked actions, determining if any blocked action is connected thereto;
creating a dependency map based on relationships between the user actions thus determined;
sending the consolidated backend actions to the one or more backend enterprise systems based on the dependency map.

10. The system of claim 9, wherein the unblocked actions are sent to the one or more backend enterprise systems in parallel.

11. The system of claim 9, wherein the mobile framework server is further operable to perform:
for a sync failure associated with a first unblocked action, skipping the first unblocked action and any blocked action connected thereto; and
continually processing at least a second unblocked action of the unblocked actions.

12. The system of claim 8, wherein the mobile framework server is further operable to perform:
responsive to a request from the mobile device or a notice from a backend enterprise system, overriding the default system operation, dynamically adding a second new subscription for the use, obtaining record details associated with the second new subscription, transforming the record details into new subscription data, and sending the new subscription data to the mobile device.

13. The system of claim 8, wherein the user is one of a plurality of users on a list prepared by the mobile framework server based on subscription rules and sent to the first backend enterprise system.

14. The system of claim 8, wherein the CDM comprises subscription hierarchies, each subscription hierarchy containing a set of subscriptions, wherein each CDM object is directly associated with a subscription, and wherein the subscription format is an object-agnostic format.

15. A computer program product comprising at least one non-transitory computer readable medium storing instructions translatable by a mobile framework server to perform a default system operation including:
obtaining, periodically from a first backend enterprise system, data object information for a user who subscribed or is assigned to receive enterprise data via the mobile framework server;
determining that the data object information indicates a change in data object records assigned to or associated with the user;
determining that the change is associated with a new data object record;
determining that a new subscription is needed for the new data object record;
determining a plurality of fields for the new data object record using a canonical data model (CDM), wherein each CDM object in the CDM includes a CDM object definition specifying a set of data fields particular to the CDM object;
determining where enterprise data for the plurality of fields is stored;
determining queries for obtaining the enterprise data from one or more backend enterprise systems;
querying the one or more backend enterprise systems using the determined queries;
transforming the enterprise data received from the one or more backend enterprise systems into subscription data in a subscription format;
storing the subscription data in a central data storage; and
sending the subscription data to a mobile device associated with the user.

16. The computer program product of claim 15, wherein the at least one non-transitory computer readable medium stores further instructions translatable by the mobile framework server to perform:
receiving, from the mobile device, a pending sync log file containing user actions performed within a period of time;
consolidating the user actions;
removing any field-level conflicts;
creating consolidated backend actions, comprising:
determining which of the user actions are unblocked actions;
determining if any set of actions are combinable;
for each of the unblocked actions, determining if any blocked action is connected thereto;
creating a dependency map based on relationships between the user actions thus determined;
sending the consolidated backend actions to the one or more backend enterprise systems based on the dependency map.

17. The computer program product of claim 16, wherein the unblocked actions are sent to the one or more backend enterprise systems in parallel.

18. The computer program product of claim 16, wherein the at least one non-transitory computer readable medium stores further instructions translatable by the mobile framework server to perform:
for a sync failure associated with a first unblocked action, skipping the first unblocked action and any blocked action connected thereto; and
continually processing at least a second unblocked action of the unblocked actions.

19. The computer program product of claim 15, wherein the at least one non-transitory computer readable medium stores further instructions translatable by the mobile framework server to perform:
responsive to a request from the mobile device or a notice from a backend enterprise system, overriding the default system operation, dynamically adding a second new subscription for the use, obtaining record details associated with the second new subscription, transforming the record details into new subscription data, and sending the new subscription data to the mobile device.

20. The computer program product of claim 15, wherein the CDM comprises subscription hierarchies, each subscription hierarchy containing a set of subscriptions, wherein each CDM object is directly associated with a subscription, and wherein the subscription format is an object-agnostic format.
